(19) United States
(12) Patent Application Publication
(10) Pub. No.: US 2024/0394064 A1
(43) Pub. Date: Nov. 28, 2024

(54) Apparatus and Method for Implementing a Loop Prediction of Multiple Basic Blocks

(71) Applicant: Condor Computing Corporation, San Jose, CA (US)

(72) Inventor: Thang Tran, Austin, TX (US)

(73) Assignee: Condor Computing Corporation, San Jose, CA (US)

(21) Appl. No.: 18/796,021

(22) Filed: Aug. 6, 2024

Related U.S. Application Data
(63) Continuation-in-part of application No. 18/135,481, filed on Apr. 17, 2023.
(63) Continuation-in-part of application No. 18/603,171, filed on Mar. 12, 2024.
(60) Provisional application No. 63/368,280, filed on Jul. 13, 2022.

(51) Int. Cl. G06F 9/38; G06F 9/30

(52) U.S. Cl. CPC G06F 9/3806; G06F 9/30065

(57) ABSTRACT

A processor includes a branch execution unit to detect a dual basic-block loop type where a second basic block jumps to the start address of a first basic block. The dual basic-block loop includes a predicted loop count to write to an entry of a branch target buffer (BTB). Two basic-blocks loop of the loop prediction from BTB forms a loop buffer in an instruction queues of the processor to seamlessly sending loop instructions from plurality of iterations to the next pipeline stage.

### CROSS-REFERENCE TO RELATED APPLICATIONS

This application is:
1. a Continuation-in-Part of U.S. application Ser. No. 18/135,481, filed Apr. 17, 2023, entitled “Executing Phantom Loops in a Microprocessor” (“First Parent Application”), which claims the benefit of U.S. Provisional Patent Application No. 63/368,280 filed Jul. 13, 2022 (“First Parent Provisional Application”); and
2. a Continuation-in-Part of U.S. application Ser. No. 18/603,171, filed Mar. 12, 2024, entitled “Apparatus and Method for Implementing Many Different Loop types in a Microprocessor” (“Second Parent Application”).

This application claims priority to:
1. First Parent Application;
2. First Parent Provisional Application; and
3. Second Parent Application;
   collectively, “Priority References,” and hereby claims benefit of the filing dates thereof pursuant to 37 C.F.R. § 1.78 (a).

The subject matter of the Priority References, each in its entirety, is expressly incorporated herein by reference.

### FIELD OF THE INVENTION

The present invention relates to the field of computer processors. More particularly, it relates to execution and prediction of loops in computer processors.

### BACKGROUND

In general, in the descriptions that follow, the first occurrence of each special term of art that should be familiar to those skilled in the art of integrated circuits (“ICs”) and systems will be italicized. In addition, when a term that may be new or that may be used in a context that may be new, that term will be set forth in bold and at least one appropriate definition for that term will be provided.

Loops are frequently used in many applications, i.e., artificial intelligence, machine learning, digital signal processing. In some applications, the number of iterations can be in hundreds or thousands. The typical loop comprises of a basic block where a basic block is defined as a straight-line code sequence with no branches in except to the entry, and no branches out except at the exit and the target address of the branch at the exit is the entry. The loops can be fetched many times from the instruction cache which is a major factor in power consumption. In some benchmarks, the loop comprises more than 1 basic block and not predicting to execute this type of loop is a missed opportunity for saving power and improving performance.

Thus, there is a need for a microprocessor which efficiently predicts multiple basic-blocks loops, consumes less power, has a simpler design, and is scalable with consistently high performance.

### BRIEF SUMMARY OF THE INVENTION

In a microprocessor that can decode, issue, and execute multiple instructions in a clock cycle, a branch prediction unit that predicts future instructions with high accuracy is crucial for performance. In one embodiment, the branch target buffer of a branch prediction unit consists of a plurality of basic blocks wherein the basic block is defined as a straight-line code sequence with no branches in except to the entry, and no branches out except at the exit. The instruction address at the entry point (the start address) is used to look up the branch target buffer which contains information for the instruction address at exit point (the end address), the instruction address for instruction after the exit point (the next address), and the instruction address for the target instruction (the target address). In this invention, a loop comprises of multiple basic blocks that is repeated many times. An instruction fetch unit includes an instruction cache queue to keep the fetched instructions before sending them to the instruction decode unit. The loops are implemented in the instruction cache queue.

In a disclosed embodiment, the branch target buffer includes different predicted branch instruction types wherein the branch instruction types can be expanded to include different loop types. Specifically, the loop types are based on the number of basic blocks in a loop. In an embodiment, the loop types can be classified as single or dual basic-block loops. Different methods are used to handle different loop types.

Detection of the single basic-block loop is straight forward, if the target address of the basic block is the same as the start address, then it is a loop. For dual basic-block loop, the target address of the second basic block is the same as the start address of the first basic block and by default the target address of the first basic block is the same as the start address of the second basic block. The difference is that the first basic block is a forward branch and the second basic block is the backward branch.

### BRIEF DESCRIPTION OF THE SEVERAL VIEWS OF THE DRAWINGS

Aspects of the present invention are best understood from the following description when read with the accompanying figures.

FIG. 1 is a block diagram illustrating a processor-based data processing system in accordance with present invention;

FIG. 2A is a block diagram illustrating a basic block concept for branch prediction and formation of a basic block for loop;

FIG. 2B is a block diagram illustrating formation of multiple basic blocks for a loop dual basic blocks;

FIG. 3 is a block diagram illustrating fetching instructions in the instruction fetch unit and prediction instructions in the branch prediction unit to an instruction queue;

FIG. 4 is a block diagram illustrating an exemplary of the dual basic-block loop in an instruction queue comprising of a loop buffer;

FIG. 5 is a block diagram illustrating an example of unrolling of loop instructions in a virtual instruction queue;

FIG. 6 is a block diagram illustrating encoding of branch types and different loop types; and

FIG. 7 is a block diagrams illustrating example of encoding in multiple entries of a branch target buffer.

### DETAILED DESCRIPTION

The following description provides different embodiments for implementing aspects of the present invention. Specific examples of components and arrangements are described below to simplify the explanation. These are merely examples and are not intended to be limiting. For example, the description of a first component coupled to a second component includes embodiments in which the two components are directly connected, as well as embodiments in which an additional component is disposed between the first and second components. In addition, the present disclosure repeats reference numerals in various examples. This repetition is for the purpose of clarity and does not in itself require an identical relationship between the embodiments.

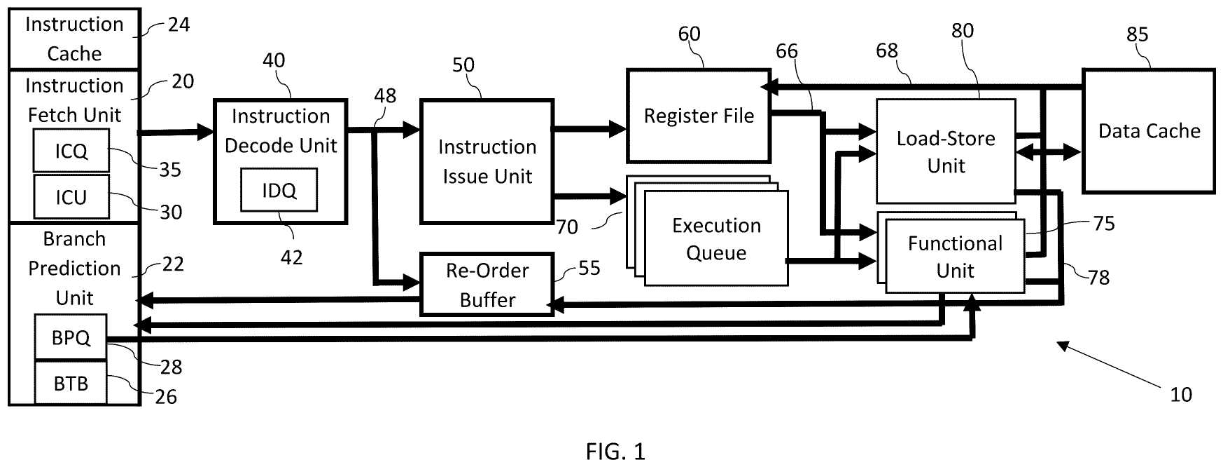

FIG. 1 is a block diagram of a microprocessor-based data processing system. The exemplary system includes a microprocessor 10 having an instruction fetch unit (“IFU”) 20, a branch prediction unit 22, an instruction cache 24, an instruction decode unit 40, an instruction issue unit 50, a re-order buffer 55, a register file 60, a plurality of execution queues 70, a plurality of functional units 75, a load-store unit 80, and a data cache 85. The microprocessor 10 includes a plurality of read buses 66 to transport data from registers in the register file 60 to the functional units 75 and the load-store unit 80. The system also includes a plurality of write buses 68 to transport result data from the functional unit 75, the load-store unit 80, and the data cache 85 to the register file 60. The functional unit 75 and the load-store unit 80 also notify the re-order buffer 55 of completion of instructions. The instruction decode unit 40 sends a plurality of instructions through bus 48 to the instruction issue unit 50 and the re-order buffer 55. The re-order buffer 55 keeps track of the order of instructions as they are executed out-of-order in the execution pipeline from instruction issue unit 55 to the data cache 85. The completed instructions in the re-order buffer 55 are retired in-order. Branch execution unit, one of the functional units 75, is coupled to the re-order buffer 55 and the branch prediction unit 22 for branch misprediction to flush all subsequent instructions and to fetch instruction from new instruction address.

During operation of the microprocessor system 10, the IFU 20 fetches the next instruction(s) from the instruction cache 24 to send to the instruction decode unit 40. One or more instructions can be fetched per clock cycle from the IFU 20 depending on the configuration of microprocessor 10. For higher performance, an embodiment of microprocessor 10 fetches more instructions per clock cycle for the instruction decode unit 40. For low-power and embedded applications, an embodiment of microprocessor 10 might fetch only a single instruction per clock cycle for the instruction decode unit 40. If the instructions are not in the instruction cache 24 (commonly referred to as an instruction cache miss), then the IFU 20 sends a request to external memory (not shown) to fetch the required instructions. The external memory may consist of hierarchical memory subsystems, for example, an L2 cache, an L3 cache, read-only memory (“ROM”), dynamic random-access memory (“DRAM”), flash memory, or a disk drive. The external memory is accessible by both the instruction cache 24 and the data cache 85. The IFU 20 is also coupled with the branch prediction unit 22 for prediction of the next instruction address when the branch is detected and predicted by the branch prediction unit 22. In one embodiment, the branch prediction unit 22 comprises of a branch target buffer (“BTB”) 26 which is based on basic block, and a branch prediction queue (“BPQ”) 28 to keep track of all the predicted branches in the execution pipeline. The IFU 20 comprises of an instruction cache control unit (“ICU”) 30 to access the instruction cache 24 for cache hit or miss indication and to fetch an instruction cache line from the instruction cache 24 or external memory (not shown) to an instruction cache queue (“ICQ”) 35 for holding fetched instructions before sending to the instruction decode unit 40. The instruction decode unit 40 consists of an instruction decode queue (“IDQ”) 42 to hold the instruction before sending to the instruction issue unit 50.

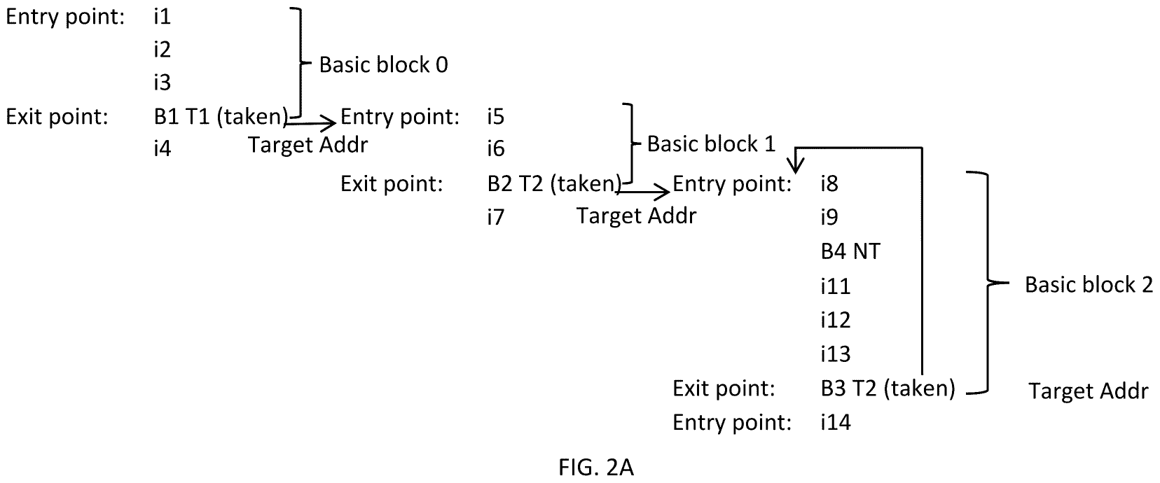

A basic block comprises a starting address which is the entry point of the basic block, an ending address which is the exit point of the basic block, and a target address which is the starting address of the next basic block if the branch is taken. The ending address is necessary to mark the branch as the predicted branch for the branch execution unit 22 and to calculate the starting address of the next basic block if the branch is not taken. FIG. 2A illustrates 3 basic blocks with different sizes. The first basic block 0 has the entry point with instruction i1 and the exit point with the branch B1 where the target address T1 is the entry point of the basic block 1. The basic block 1 has the entry point with instruction i5 and the exit point with the branch B2 where the target address T2 is the entry point of the basic block 2. The basic block 2 has the entry point with instruction i8 and the exit point with the branch B3 where the target address T2 is the entry point of the basic block 2. Note that the basic block 2 has another branch instruction B4 but this branch instruction is not-taken. As long as this branch B4 remains not-taken then the basic block 2 is the same. If the branch B4 is taken which is a branch misprediction from the branch execution unit which is one of the functional unit 75, then the basic block 2 splits into 2 basic block, the first basic block is from i8 to B4 and the second basic block is from ill to B3. The predicted basic blocks are kept in the BTB 26. The BTB 26 is a cache array which comprises of a tag array and data array. The tag array comprises of plurality of entries of start addresses and the data array comprises of target address, ending address, branch type which includes loop prediction, and predicted loop count. The branch type comprises of unconditional branch, conditional branch, call and return, and different loop types.

The basic block 2 of FIG. 2A illustrates a loop where the target T2 of the last branch instruction B3 is the address of the entry point of the basic block 2. The branch prediction unit (one of the functional units 75) detects the loop by comparison of the target address T2 with the start address (the entry point) of the basic block 2 where address matching means a loop. The sequence of basic block 2 must be executed at least twice by the branch execution unit before it is set up as loop prediction in the BTB 26. The first execution of basic block 2, the prediction is not yet in the BTB 26 and the target T2 of branch instruction B3 would be a miss in BTB 26. On the second misprediction, the target T2 would be a hit with loop prediction in BTB 26. The number of bytes from the entry point to the exit point is also calculated by the branch execution queue for the loop length. A loop is a basic block which is natural for using basic block as part of the branch prediction unit. For simplicity, the loop length is equal or smaller than the ICQ 35 where a part of the ICQ is converted into a loop buffer. The loop buffer is capable of issuing multiple iterations of the loop in a clock cycle. In many benchmarks, the basic block size has 4 to 5 instructions on average, if the processor 10 issues 8 instructions per clock cycle, then about half of the execution bandwidth is wasted. Loop buffer is a great way to fill up the bandwidth of instruction issuing. Another advantage of loop prediction is that the ICQ 35 or the instruction decode queue 42 is responsible to issue all iterations of the loop to the decode unit 40. Without the loop buffer, the branch prediction unit 22 predicts every iteration of the loop to the IFU 20 where each iteration of the loop is fetched from the instruction cache 24 to the decode unit 40. Accessing the branch target buffer 26 and the instruction cache 24 for every iteration of the loops consumes much more power. In one embodiment, once the loop is predicted in the BTB 26, then the misprediction due branch instruction B4 is ignored and does not split the basic block 2. The basic block 2 remains a predicted loop in the BTB 26.

Since the loop buffer is implemented in the ICQ 35, the loop length must be known in order to predict the loop in the BTB. The loop length is calculated from the entry-point and exit-point addresses. In one embodiment, the ICQ 35 contains a plurality of instructions and the number of instructions is determined based on the starting address and ending address of the loop. In one embodiment, the ICQ 35 size is designed to be 1 or multiple of the cache line. For example, the ICQ 35 size is 64 bytes which is 2 cache lines of 32-byte and can hold a loop with the starting address 0f 0x0000_0000 and ending address of 0x0000_0030, or 48 bytes or 12 4-byte instructions. The number of bytes in a basic block is referred to as loop length for a loop. The instructions can be of different sizes, i.e. 4-byte and 2-byte instructions, and 48 bytes loop length could be 16 instructions. In another embodiment, the loop buffer can be implemented in the IDQ 42 where the IDQ size is based on number of instructions instead of the number of bytes. In the above example, the IDQ 42 size must be equal or greater than 16 entries to keep the loop instructions. The instruction issue unit 50 keeps track of the instruction count when the entry-point address is encountered and sends the instruction count with the branch instruction to the branch execution unit 75 for determining if the loop buffer can be implemented in the IDQ 42.

FIG. 2B illustrates the same 3 basic blocks as in FIG. 2A with the exception that the branch instruction B3 jumps back to the entry point, T1, of the basic block 1. The branch execution unit (one of the functional units 75) detects the loop by comparison of the target address T2 with the start address (the entry point) of the basic block 1 where address matching means a dual basic-block (“2BB”) loop. The lengths of the first and second basic blocks are combined into the loop length for the 2BB loop. The sequence of dual basic blocks must be executed twice by the branch execution unit before it is set up as loop prediction in the BTB 26. Two basic blocks of the loop prediction take up 2 entries in the branch target buffer 26 and the branch type specifies the loop prediction as first and second basic block loop. The 2BB loop is for illustration purpose which does not limit the number of basic blocks in the loop prediction to dual basic blocks. In one embodiment, once the 2BB loop is predicted in the BTB 26, then the misprediction due branch instructions B2 and B4 are ignored. The branch instruction B4 does not split the basic block 2. The first and second basic-block loop prediction remains in the BTB 26

As the instructions are fetched from the instruction cache or external memory in case of cache miss, they are sent directly to the decode unit 40 if the instruction queue is empty. If the ICQ 35 is not empty, then the fetched instructions are written to the ICQ 35 before sending to the decode unit 40. The ICQ 35 can send instructions to the decode unit 40 when it is a valid instruction fetch and the branch prediction unit 22 indicates valid prediction. The valid prediction can be a hit or miss from the BTB 26. If the BTB 26 indicates that a loop is predicted, then all instructions of the loop must be written to the ICQ 35 before sending to the decode unit 40. The ICQ 35 becomes the loop buffer. The loop count is decremented every time the last instruction of the loop is sent to the decode unit 30. If the loop count is larger than the number of bits used in the BTB 26, then the loop count is set to the maximum value (all 1's). There are 2 options: (1) the loop count remains set until it is mispredicted by the branch execution unit 75, or (2) the loop count is updated by the branch execution unit 75. The loop may not have a loop count, where the content of a variable register is compared to a fixed value which could be in another register. In this case, only option (1) is applicable.

As a branch is executed in the branch execution unit 75, the predicted branch information is provided by the BPQ 28. The predicted branch information comprises of the start address, the end address, the target address, branch type which includes loop type, and taken or not-taken prediction. The branch execution unit 75 validates the predicted branch or update the branch information. One such update is the loop prediction if the target address and the start address are the same. For dual basic-block loop, the starting addresses of the current and last basic blocks are provided from the BPQ 28 to the branch execution queue 75, where the branch execution unit 75 indicates the appropriate loop type to update the BTB 26.

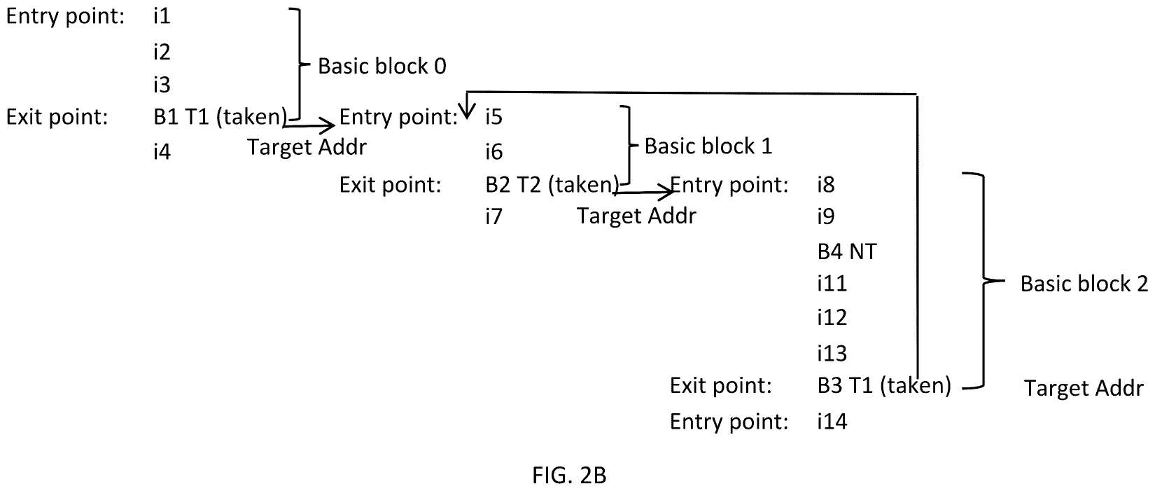

Turning now to FIG. 3 which illustrates the front-end of the microprocessor to predict and fetch instructions to the instruction decode unit 40. The IFU 20 includes an ICU 30 which fetches instructions from the instruction cache 24 based on the prediction of the BTB 26 for hit/miss information and an ICQ 35 to hold the cache line data from the data array 23 of the instruction cache 24. The ICU 30 checks the tag array 21 if the instruction address matches with a cache line entry in the instruction cache 24. In an embodiment, the tag array 21 is accessed for hit before accessing the data array 23. If the instruction address is not in the instruction cache 24 (cache miss), the instruction control unit 30 sends request to external memory (not shown) to fetch the cache line. The ICQ 35 comprises of a single or multiple cache lines, as an example, the ICQ 35 can hold 2 cache lines of 32-byte or 16 instructions. Pluralities of instructions are sent from the ICQ 35 to the IDQ 42 of the instruction decode unit 40 where the instructions are decoded and sent to the instruction issue unit 50 and the re-order buffer 55 through the bus 48.

The IFU 20 is also coupled to the branch prediction unit (“BPU”) 22 which predicts the next instruction address when a branch is detected by the branch prediction unit 22. The branch prediction unit 22 includes a BTB 26 that stores a plurality of entry-point addresses, branch types including loops, loop counts, exit-point addresses, and target addresses of stored basic blocks. The instructions are predicted and fetched ahead of the pipeline execution. The BPU 22 includes a BPQ 28 to track many predicted basic blocks as they progress through many pipeline stages of the microprocessor 10. In one embodiment, the PC is calculated at 3 different stages: in BPQ 28, in instruction issue unit 50, and in a retire stage of the re-order buffer 55 of the microprocessor 10. The BPQ 28 also tracks the predicted loop to ensure termination of the loop for proper calculation of PC in the instruction issue unit 50 and in the re-order buffer 55 of the microprocessor 10.

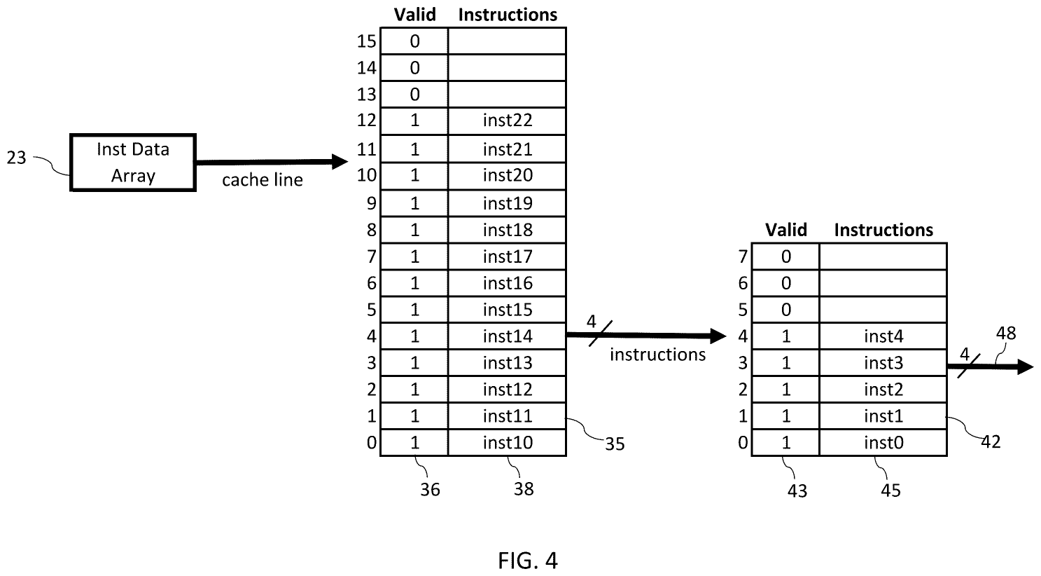

The BPQ 28, the ICQ 35, and the IDQ 42 are each designated as circular buffer with read and write pointers rotating from the tail entry to the head entry of the queue. The loop buffer is also a circular buffer within the queue with its own loop start pointer and loop end pointer where the loop end pointer wraps around to the loop start pointer. Numerous iterations of the loop are issued to the next pipeline stage will be shown later in example of FIG. 5. The number of instructions in ICQ 35 or in IDQ 42 is capable of storing a number of loop instructions in a loop. In one embodiment, the ICQ 35 comprises of 1 or a plurality of cache lines from the instruction data array 23 of the instruction cache 24. In another embodiment, the IDQ 42 comprises of 1 or a plurality of number of instructions to be decoded in each cycle. The illustrated embodiment of FIG. 3 shows that the instruction tag array 21 is accessed before the instruction data array 23 is accessed. The dual basic-block loop can be detected by the branch execution unit 75 to be implemented in the ICQ 35 or the IDQ 42 but the branch execution unit 75 can be configured to detect any number of loop types. In one embodiment, the ICQ 35 or the IDQ 42 is selected to store the predicted loop depending on the loop length of the predicted loop.

In FIG. 3, the loop is predicted by the BTB 26, and the predicted instruction address is sent to the IFU 20 and the BPQ 28. The loop is sent to one of the queues such as the IDQ 42 or the ICQ 35. The BPQ 28 keeps track of all predicted basic blocks by storing the entry and exit point addresses as the basic blocks progress through the pipeline stages of the microprocessor 10. The loop count for a loop is also tracked in the BPQ 28. From the point of view of the branch execution unit 75 each iteration of the loop is predicted as taken until the last iteration of the loop. The BPQ 28 is coupled to the branch execution unit 75 to provide the correct prediction information. The predicted loop count is sent with the predicted loop to the queues so that the correct number of loop iterations is sent to the execution pipeline.

Referring back to FIG. 1 the instruction decode unit 40 decodes instructions for instruction type and register operands. The register operands, as an example, may consist of 2 source operands and 1 destination operand. The operands are referenced to registers in the register file 60. The decoded instructions are sent to instruction issue unit 50 to dispatch instructions to the execution queues 70 where the instructions wait until data dependencies and resource conflicts are resolved before being issued to the functional unit 75 or the load-store unit 80. The load-store unit 80 accesses the data cache 85 to read data for a load instruction and to write store data for a store instruction. The data for load and store instructions may not be in the data cache 85 (commonly referred to as data cache miss), and if this is the case then the load-store unit 80 sends a request to external memory (not shown) to fetch the required data. The result data from the data cache 85, the load-store unit 80, and the functional units 75 are written back to the register file 60 through the write buses 68. The source operand data are read from the register file 60 to the functional units 70 and the load-store unit 80 on a read bus 66.

The integrated circuitry employed to implement the units shown in the block diagram of FIG. 1 may be expressed in various forms including as a netlist which takes the form of a listing of the electronic components in a circuit and the list of nodes that each component is connected to. Such a netlist may be provided via an article of manufacture as described below.

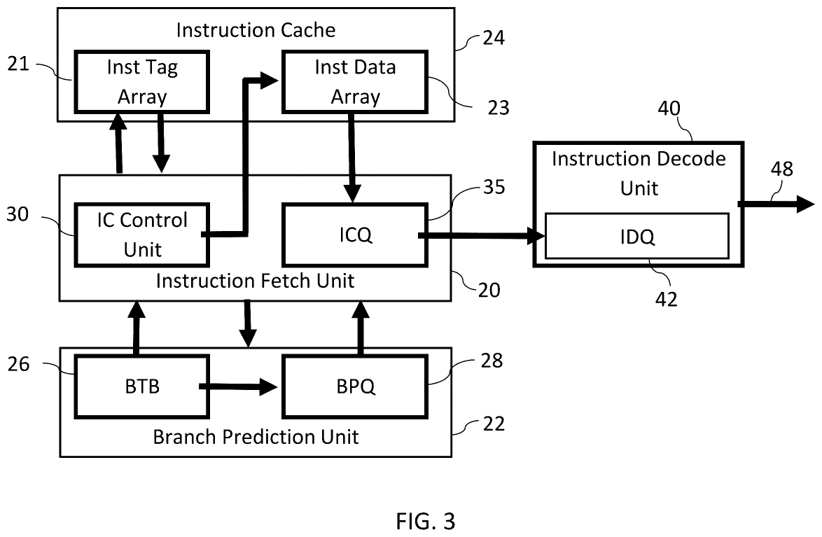

FIG. 4 illustrates an embodiment of the queue structures for the IDQ 42 and the ICQ 35. Each queue comprises 2 fields, valid and data. The ICQ 35 has 16 entries each with valid field 36 and instruction field 38. The IDQ 42 has 8 entries each with valid field 42 and instruction field 45. The queues may include more fields (not shown) to keep predecode information, branch and loop information. In an example, the instruction cache line has 32 bytes and the ICQ 35 can store up to 2 cache lines. The ICU 30 sends a request to read the instruction data array 23 to read a cache line and write to the ICQ 35 as long as the ICQ 35 has enough available entries for the cache line. If the ICQ 35 does not have enough entries available to permit writing of the entire cache line into the ICQ 35 then a partial cache line can be written into the ICQ 35 and the rest of the cache line is written as more ICQ 35 entries become available. The ICQ 35 sends 4 instructions to the IDQ 42, and the IDQ 42 decodes the instruction in the instruction decode unit 40 and sends them through bus 48 to the instruction issue unit 50 and the re-order buffer 55. The instructions from the ICQ 35 are written to the IDQ 42 as long as the IDQ 42 has enough available entries. The ICQ 35 can send fewer than 4 instructions to the IDQ 42. In each queue, the loop is part of the queue to be established in the IDQ 42 or the ICQ 35 as long as the number of instructions in the loop is smaller than the queue size.

FIG. 5 shows an example implementation of a loop in the ICQ 35. As shown, inst2 to inst15 are valid and the loop has 11 valid instructions, inst2 to inst12. In one embodiment, for simplicity, the instructions before the loop are issued independent of the loop instructions. Meaning that inst0 and inst1 are issued to the instruction decode unit 40 in 1 cycle and loop instructions, inst2 to inst5, are issued to the instruction decode unit 40 in the next cycle. The loop start pointer and loop end pointer are used to identify the first and last instructions of the loop. The iterations of loop instructions are virtually unrolled by many iterations so that instructions can be dispatched seamlessly across the loop iteration as shown in virtual view of ICQ 35A. The read pointer 37 is incremented by the number of instructions dispatched on bus to IDQ 42 as shown in 2 consecutive cycles by incrementing the read pointer 37 twice. Each time the instruction associated with the loop end pointer, inst12, is dispatched, the loop count 39 is decremented. The loop count 39 can be decremented more than 1 in a single cycle if loop length is small. When the loop count 39 is zero, then the loop is completed, and the read pointer is converted back to the read pointer for the ICQ 35. For example, if the loop count is zero after the first iteration, then the read pointer will be inst14 since the read pointer is 1 instruction more than the exit point. The read pointer is incremented for every 4 instructions sending to IDQ 42, the dashed read pointers for virtual ICQ 35A. The virtual unrolling results in instructions in a loop being automatically provided for the multiple iterations of the loop to the next stage in the processor pipeline, which comprises the instruction decode unit 40. In operation, for a loop with 32 iterations, if it is unrolled twice then the instructions of the loop are duplicated such that the loop will have 16 iterations. Unrolling the loop four times results in duplicating the instructions of the loop four times such that the loop will have eight iterations. A full unrolling of the loop will result in the loop being duplicated 32 times such that there are no iterations of the loop. In the virtual unrolling referred to the above loop may be fully unrolled and four instructions (in this example) are read at a time to send to the next stage. The word virtual in the virtual unroll operation means that the issue logic sees only four instructions at a time in the full unrolling of the loop. From the instruction point of view, it looks like the loop is fully unrolled in the ICQ 35A.

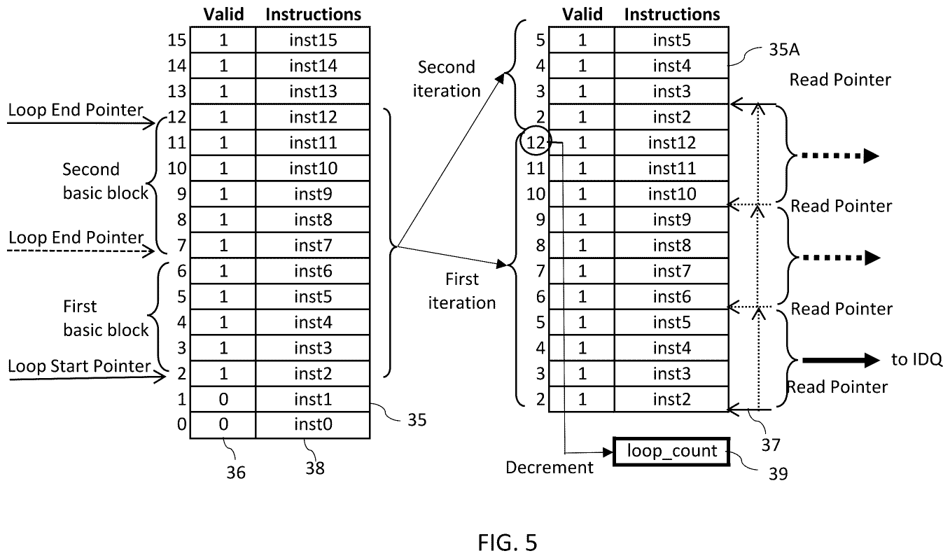

FIG. 5 shows a dual-basic-block loop in the ICQ 35. As the first basic block, inst2 to inst6, is predicted as “first basic block of the 2BB loop” by the BTB 26. The ICQ 35 sets the loop start pointer at entry #2, and loop end pointer at entry #7, 1 entry beyond the loop length of the first BB. The loop buffer is enabled but no instruction can be sent to the instruction decode unit 40 until all instructions in the predicted loop are valid. The BTB 26 continues to predict “the second basic block of the 2BB loop” and sends second basic block to IFU 20 to fetch the next cache line to the ICQ 35. The second basic block prediction includes the instruction length to calculate the loop end pointer for the ICQ 35 which is set at entry #12 for the last instruction of the second basic block. When all instructions in the predicted loop are valid, inst2 to inst12, then the instructions are sent to the IDQ 42. The branch type in the BTB entry specifies the loop prediction type as shown in FIG. 6.

FIG. 6 shows a sample encoding for branch types which is stored with every predicted basic block prediction in the BTB 26. The normal branch types are return, call, unconditional, and conditional branches. In one embodiment, the return, call, and unconditional branches are always taken while the conditional branch can be taken or not-taken depending on a prediction algorithm. The predicted loops are encoded as shown in the third, fourth, and eighth rows of the branch types. Note that the most significant bit of the single loop prediction and second-basic-block loop prediction are “0” indicating that the loop basic block is not taken. The first-basic-block loop prediction is “1” indicating taken prediction. The BTB 26 fetches the sequential basic block by using the exit point address of the basic block for non-taken prediction and uses the target address for taken prediction.

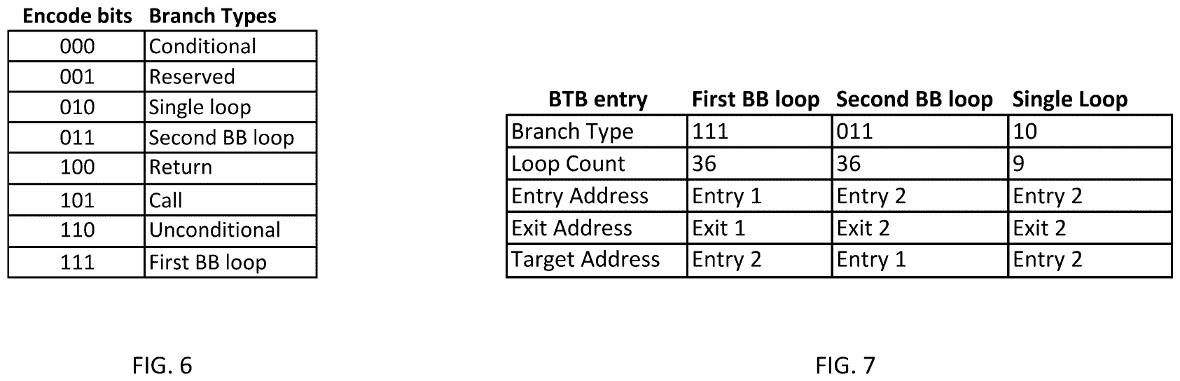

FIG. 7 shows contents of a BTB 26 entry which includes branch type, loop count, entry-point address, exit-point address, and target address. The second column is an example of the first-basic-block loop in reference to the basic block 1 of example FIG. 2B. The target address of the basic block 1 is T2 which is the entry point of the basic block 2. The branch type of “111” indicates that the branch is predicted taken. The third column is an example of the second-basic-block loop in reference to the basic block 2 of example FIG. 2B. The target address of the basic block 2 is T1 which is the entry point of the basic block 1. The branch type of “011” indicates that the branch is predicted non-taken meaning that the BTB 26 starts the next prediction with sequential address from the exit point of the basic block 2 which is the address for instruction i14 of FIG. 2B. For completeness, the last column of FIG. 7 is an example of the single loop prediction in reference to the basic block 2 of example FIG. 2A. The target address of the basic block 2 is T2 which is the entry point of the basic block 2. The branch type of “010” indicates that the branch is predicted non-taken meaning that the BTB 26 starts the next prediction with sequential address from the exit point of the basic block 2 which is the address for instruction i14 of FIG. 2A

Each of the units shown in the block diagram of FIG. 1 can be implemented in integrated circuit form by one of ordinary skill in the art in view of the present disclosure. The integrated circuitry employed to implement the units shown in the block diagram of FIG. 1 may be expressed in various forms including as a netlist which takes the form of a listing of the electronic components in a circuit and the list of nodes that each component is connected to. Such a netlist may be provided via an article of manufacture as described below.

In other embodiments, the units shown in the block diagrams of the various figures can be implemented as software representations, for example in a hardware description language (such as for example Verilog) that describes the functions performed by the units described herein at a Register Transfer Level (“RTL”) type description. The software representations can be implemented employing computer-executable instructions, such as those included in program modules and/or code segments, being executed in a computing system on a target real or virtual processor. Generally, program modules and code segments include routines, programs, libraries, objects, classes, components, data structures, etc. that perform particular tasks or implement particular abstract data types. The program modules and/or code segments may be obtained from another computer system, such as via the Internet, by downloading the program modules from the other computer system for execution on one or more different computer systems. The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a non-transitory computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The aforementioned implementations of software executed on a general-purpose, or special purpose, computing system may take the form of a computer-implemented method for implementing a microprocessor, and also as a computer program product for implementing a microprocessor, where the computer program product is stored on a non-transitory computer readable storage medium and includes instructions for causing the computer system to execute a method. The aforementioned program modules and/or code segments may be executed on suitable computing system to perform the functions disclosed herein. Such a computing system will typically include one or more processing units, memory and non-transitory storage to execute computer-executable instructions.

The foregoing explanation described features of several embodiments so that those skilled in the art may better understand the scope of the invention. Those skilled in the art will appreciate that they may readily use the present disclosure as a basis for designing or modifying other processes and structures for carrying out the same purposes and/or achieving the same advantages of the embodiments herein. Such equivalent constructions do not depart from the spirit and scope of the present disclosure. Numerous changes, substitutions and alterations may be made without departing from the spirit and scope of the present invention.

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

What is claimed is:

1. A processor comprising:
a branch target buffer (BTB) that stores a predicted loop type of a loop, the BTB including a plurality of BTB entries addressable by an entry address, each of the BTB entries including a branch type comprising a loop type and a loop count, wherein the loop type comprises of a first basic block of a predicted loop and a second basic block of the predicted loop and wherein the combination of the first and second basic blocks is a dual basic-block loop prediction with a plurality of iteration of the loop; and
an instruction queue that processes a plurality of iterations of the loop in response to the loop being classified as dual basic-block loop.

2. The processor of claim 1 wherein the dual basic-block loop is processed in a second instruction queue if the number of instructions is fitted into the second instruction queue.

3. The processor of claim 1 wherein the instruction queue comprises:
a plurality of instruction cache line addresses and wherein the predicted loop is classified as function of a number of cache lines required for loop instructions and wherein the number of cache lines fit into the instruction queue.

4. The processor of claim 1 further comprising:
an instruction issue unit that dispatches instructions to one or more execution queues;
a branch execution unit that detects the dual basic-block loop and generates for the loop, the predicted loop type and stores for the loop, the branch type, loop type and loop count with the entry address for the loop to the BTB, the branch execution unit comprising a branch prediction queue that,
tracks branch predictions including predicting loops; and
tracks a predicted loop count in the branch execution unit and the instruction issue unit for instruction address calculation.

5. The processor of claim 1 wherein the first basic block of the dual basic-block loop is taken with the target address is the entry point of the second basic block of the dual basic-block loop.

6. The processor of claim 1 wherein the instruction queue operates to virtually unroll instructions in the corresponding plurality of iterations to a next pipeline stage of the processor.

7. The processor of claim 2 wherein one or more of the first instruction queue and the second instruction queue process sequential instructions after the loop concurrently during execution of the loop.

8. The processor of claim 1 wherein the loop type of the loop corresponds to a first basic-block loop with taken prediction wherein the loop type of the loop corresponds to a second basic-block loop with non-taken prediction.

9. The processor of claim 1 wherein a branch execution unit detects a loop type based on a plurality of basic blocks and the loop count to write to different basic block loop type in a plurality of entries in the BTB.

10. The processor of claim 1 wherein the instruction queue receives instructions from the first basic block of the dual basic-block loop prediction, and delays issuing of the loop instruction to next stage until receives instructions from the second basic block of the dual basic-block loop prediction.

11. The processor of claim 1 wherein the branch misprediction due to the first basic block of the dual basic-block loop is ignored once the dual basic-block loop prediction is written into the branch target buffer.

12. The processor of claim 1 wherein the branch misprediction due to a previously non-taken branch in the first basic block or the second basic block of the dual basic-block loop is ignored once the dual basic-block loop prediction is written into the branch target buffer.

13. A processor comprising:
a branch execution unit that identifies a loop and classifies the loop in accordance with a number of basic blocks to form a loop;
a branch target buffer (BTB), including a plurality of BTB entries addressable by an entry address, the BTB receiving from the branch execution unit, an entry address for the loop, a loop type for the loop, and a predicted loop count for the loop;
a branch prediction queue that tracks all branch predictions and tracks the predicted loop count in the branch execution unit and the instruction issue unit for program counter calculation;
an instruction queue that receives a first basic block of a dual basic-block loop prediction and delays issuing of the loop instructions until a second basic block of the dual basic-block loop prediction is received; and
the instruction queue operates to virtually unroll instructions in the corresponding plurality of iterations to a next pipeline stage of the processor.

14. A computer program product stored on a non-transitory computer readable storage medium and including computer system instructions for causing a computer system to execute a method that is executable by a processor, the method detecting a dual basic-block loop type in a series of instructions and generating a predicted loop count, the method comprising:
identifying in the series of instructions, a basic block of instructions and classifying the basic block of instructions as a first basic block of the dual basic-block loop;
identifying in the series of instructions, a basic block of instructions and classifying the basic block of instructions as a second basic block of the dual basic-block loop;
classifying the loop into one of a plurality of loop types based on a first or second basic block of the dual basic-block loop; and
sending the first and second basic blocks of instructions to an instruction queue based on the loop types of the dual basic-block loop.

15. The computer program product of claim 14 wherein the method further comprises:
generating the predicted loop count for the loop; and
generating a program counter calculation as a function of the predicted loop count.

16. The computer program product of claim 14 wherein the method further comprises:
if the loop comprises the dual basic-block loop type, virtually unrolling the loop instructions in the instruction queue; and
sending instructions from a plurality of iterations of the loop to a next pipeline stage.

17. The computer program product of claim 16 wherein the method further comprises:
writing sequential instructions after the loop into the instruction queue.

18. The computer program product of claim 17 wherein the method further comprises:
writing prediction bits associated with the first basic block loop to an entry of a branch target buffer (BTB) to cause the BTB to use a target address field of the BTB to access a basic block in the BTB that comprises the first basic block loop to access the second basic block in the BTB.

19. The computer program product of claim 18 wherein the method further comprises:
writing prediction bits associated with the second basic block loop to an entry of a branch target buffer (BTB) to cause the BTB to use an exit address field of the BTB to access a sequential basic block in the BTB for exiting the loop prediction.

20. The computer program product of claim 14 wherein the method further comprises:
ignoring the branch misprediction related to any branch within the first or second basic block of the dual basic-block loop once the dual basic-block loop is written into the branch target buffer.
